(19) United States
(12) Patent Application Publication
(10) Pub. No.: US 2025/0368567 A1
(43) Pub. Date: Dec. 4, 2025

(54) METALLIZING SYSTEM AND METHOD FOR METALLIZING A WORKPIECE

(71) Applicant: Owens-Brockway Glass Container Inc., Perrysburg, OH (US)

(72) Inventors: John Alexander González Ballén, Bogota (CO); Fredy Alexander Figueredo Ibañez, Bogota (CO); Julian David Valencia Deossa, Bogota (CO)

(21) Appl. No.: 18/680,326

(22) Filed: May 31, 2024

(51) Int. Cl. C03C 17/10; B65G 49/06; C03C 17/00; C23C 4/06; C23C 4/129

(52) U.S. Cl. CPC C03C 17/10; B65G 49/067; C03C 17/003; C03C 2218/13; C23C 4/06; C23C 4/129

(57) ABSTRACT

A metallizing system for metallizing worn workpieces to produce metallized workpieces is disclosed. The metallizing system includes a metallizing workstation, which includes a worktable configured to receive and rotate a worn workpiece, at which the worn workpiece is metallized into a metallized workpiece by being rotated through a thermal metallic spray of a flame spray torch. The metallizing system also includes a metallizer station, which includes a metallizer handler that carries a metallizing applicator. The metallizing applicator is movable towards and away from the worktable and the retained workpiece and includes the flame spray torch. The metallizing system automates the metallizing operation in that neither the worn workpiece nor the flame spray torch needs to be hand manipulated during metallizing of the worn workpiece. A method of metallizing a worn workpiece to produce a metallized workpiece is also described.

### TECHNICAL FIELD

This patent application discloses innovations related to processes and equipment for metallizing workpieces and, more particularly, to processes and equipment for metallizing workpieces including, for example, mold components used to manufacture glass containers.

### BACKGROUND

Manufacturing of a glass container typically involves receiving a charge of molten glass into a blank mold, forming the molten glass into a parison in the blank mold, transferring the parison from the blank mold to a blow mold, and forming the parison into the finished glass container in the blow mold. The molds include various mold components including, for example, mold bodies, neck rings, neck ring guide plates, guide rings, plungers, baffles, and bottom plates, which are often composed of cast iron or another material that is resistant to thermal fatigue. Despite being constructed from thermal fatigue resistant materials, the mold components tend to wear out over time from repeated contact with the molten glass and/or repeated abrasive contact with other machine components. Instead of being discarded, the mold components may be reconditioned to extend their operational lifetime and mitigate capital expenditures for tooling. The mold components may be reconditioned by metallizing the worn surfaces of the components, which involves depositing a fresh coating of metal over the worn surfaces, and machining the fresh metal to the correct size and/or surface contour for the components. Currently, worn mold components are metallized manually. Manual metallization involves individuals manipulating a worn mold component by hand while spraying metal onto the worn mold components, typically at one or more workbenches equipped with handheld oxy-acetylene torches, with varying degrees of precision. The manual nature of this process renders it susceptible to inconsistent quality between metallized components.

### SUMMARY OF THE DISCLOSURE

In accordance with one aspect of the present disclosure, a metallizing system includes a metallizing workstation and a metallizer station. The metallizing workstation includes a worktable configured to receive and rotate a worn workpiece, and the metallizer station includes a metallizer handler and a metallizing applicator carried by the metallizer handler. The metallizing applicator is movable towards and away from the worktable and includes a flame spray torch configured to deposit a metallized layer of metal onto the worn workpiece as the worn workpiece rotates relative to the flame spray torch.

In accordance with another aspect of the present disclosure, a metallizing system for metallizing worn workpieces into metallized workpieces includes an inbound pallet, an outbound conveyor, a metallizing workstation, a metallizer station, and a material handler. The inbound pallet includes a plurality of workpiece holders, each of which is configured to hold a worn workpiece, and the outbound conveyor has a conveying surface. The metallizing workstation includes a worktable having a workpiece spindle that is rotatable about a rotation axis and includes a chuck. The metallizer station includes a metallizer handler and a metallizing applicator carried by the metallizer handler. The metallizing applicator is movable towards and away from the workpiece spindle and includes a flame spray torch configured to emit a flame and receive powdered metal material into the torch flame to create a thermal metallic spray. Finally, the material handler includes a gripper arm that has a gripper end-effector. The gripper end-effector is configured to acquire a worn workpiece from the inbound pallet, transfer the worn workpiece to the metallizing workstation, and release the worn workpiece to the chuck of the workpiece spindle, and is also configured to acquire a metallized workpiece from the chuck of the workpiece spindle, transfer the metallized workpiece to the outbound conveyor, and release the metallized workpiece onto the conveying surface of the outbound conveyor.

In accordance with yet another aspect of the present disclosure, a method of metallizing a worn workpiece to produce a metallized workpiece includes several steps. One step involves delivering a worn workpiece to a rotatable workpiece spindle carried on a worktable. The rotatable workpiece spindle has a chuck and, to that end, the worn workpiece is received in the chuck. Another step of the method involves advancing a metallizing applicator towards the worktable and the worn workpiece. The metallizing applicator includes a flame spray torch that emits a flame. Still another step of the method involves rotating the workpiece spindle to rotate the worn workpiece relative to the flame spray torch such that the worn workpiece rotates through the flame to heat the worn workpiece. Yet another step of the method involves depositing a metallized layer of metal onto the worn workpiece to produce a metallized workpiece. The deposition of the metallized layer of metal is achieved by introducing a powdered metal material into the flame of the flame spray torch to create a thermal metallic spray while continuing to rotate the workpiece spindle such that the worn workpiece is rotated relative to the flame spray torch and through the thermal metallic spray. Still further, another step of the method involves retracting the metallizing applicator away from the metallized workpiece and the worktable.

### BRIEF DESCRIPTION OF THE DRAWINGS

FIG. 1 is a front, isometric, schematic view of an automatic metallizing system in accordance with an illustrative embodiment of the present disclosure;

FIG. 2 is a plan view of the metallizing system of FIG. 1;

FIG. 3 is a front-end view of the metallizing system of FIG. 1;

FIG. 4 is a right-side view of the metallizing system of FIG. 1;

FIG. 5 is an enlarged, fragmentary, isometric view of the metallizing system of FIG. 1, illustrating a portion of a metallizer handler;

FIG. 6 is an enlarged, fragmentary, side perspective view of the metallizing system of FIG. 1, illustrating a portion of a material handler;

FIG. 7 is an enlarged, fragmentary, side perspective view of the metallizing system of FIG. 1, illustrating a metallizing workstation including a pivotable worktable in a first position and a rotatable spindle, and also illustrating the material handler loading a worn workpiece onto the workstation and a front end of a metallizing applicator emitting a flame;

FIG. 8 is an enlarged, fragmentary, side perspective view of the metallizing system of FIG. 1, illustrating the metallizing applicator carried by the metallizer handler and advanced to an advanced position at the metallizing workstation;

FIG. 9 is an enlarged, fragmentary, side perspective view of the metallizing system of FIG. 1, illustrating the pivotable worktable pivoted to a second position and the metallizing applicator retracted to a retracted position by the metallizer handler;

FIG. 10 is an enlarged, fragmentary, side perspective view of the metallizing system of FIG. 1, illustrating the metallizing applicator advanced to an advanced position at the metallizing workstation;

FIG. 11 is an enlarged, fragmentary, rear perspective view of the metallizing system of FIG. 1, illustrating the metallizing applicator advanced to the advanced position at the metallizing workstation;

FIG. 12 is an enlarged, fragmentary, side perspective view of the metallizing system of FIG. 1, illustrating the pivotable worktable pivoted back to the first position and the metallizing applicator retracted back to the retracted position by the metallizer handler;

FIG. 13 is an enlarged, fragmentary, side perspective view of the metallizing system of FIG. 1, illustrating the material handler unloading a metallized workpiece from the metallizing workstation;

FIG. 14 is an enlarged, fragmentary, rear perspective view of the metallizing system of FIG. 1, illustrating the material handler loading the metallized workpiece to a conveyor; and

FIGS. 15A and 15B constitute a flowchart of a method in accordance with an illustrative embodiment of the present disclosure.

### DETAILED DESCRIPTION

A metallizing system for metallizing mold components used in the manufacture of glass containers and a method for metallizing such components are described below. However, the system and method may be used to metallize other types of components besides mold components, and thus the term “workpiece” is used herein to represent various types of metal components that may be metallized for one reason or another including the mold components mentioned above. In the past, the reconditioning of worn mold components involved retooling personnel manually manipulating an oxy-acetylene torch to spray fresh metal onto the mold components at specified workbenches to metallize the components. Such manual metallizing practices, while generally acceptable, often resulted in variances in precision and inconsistent quality from one mold component to another. The metallizing system disclosed herein automates the metallizing process and, as such, reduces the need for manual tasks to be performed when reconditioning worn mold components. By automating the metallizing operation, both process repeatability and the quality of metallized mold components can be improved.

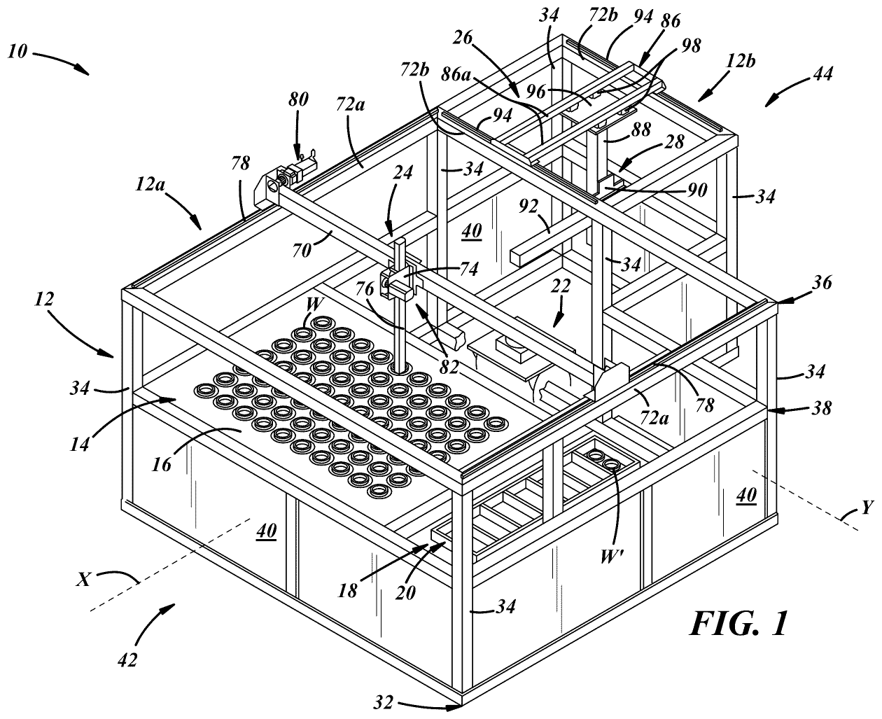

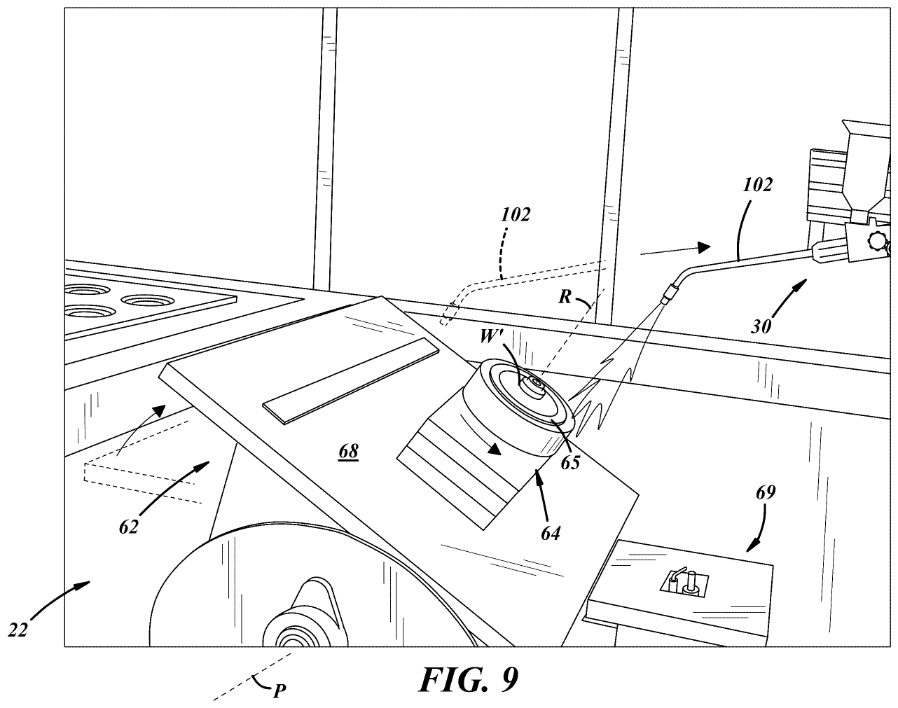

Turning now to FIG. 1, an illustrative embodiment of a metallizing system 10 is shown that includes a system frame 12 defining an operational envelope of the system 10, an inbound station 14 including an inbound pallet 16 to hold worn workpieces W to be processed, such as worn mold components, and an outbound station 18 including an outbound conveyor 20 to receive metallized workpieces W′ and convey the metallized workpieces W′ toward an outlet of the system 10. The metallizing system 10 also includes a metallizing workstation 22 to receive worn workpieces W and to then metallize the worn workpieces W to produce the metallized workpieces W′. The metallizing system 10 further includes a material handler 24 coupled to the system frame 12 to acquire worn workpieces W, move the worn workpieces W from the inbound pallet 16 to the metallizing workstation 22, and release the worn workpieces W to the metallizing workstation 22. The metallizing system 10 additionally includes a metallizer station 26 including a metallizer handler 28 coupled to the system frame 12 and a metallizing applicator 30 (FIG. 8) that is carried by the metallizer handler 28. The metallizing applicator 30, which is moveable towards and away from the metallizing workstation 22 by the metallizer handler 28, applies metal material to the worn workpieces W at the workstation 22 to produce the metallized workpieces W′.

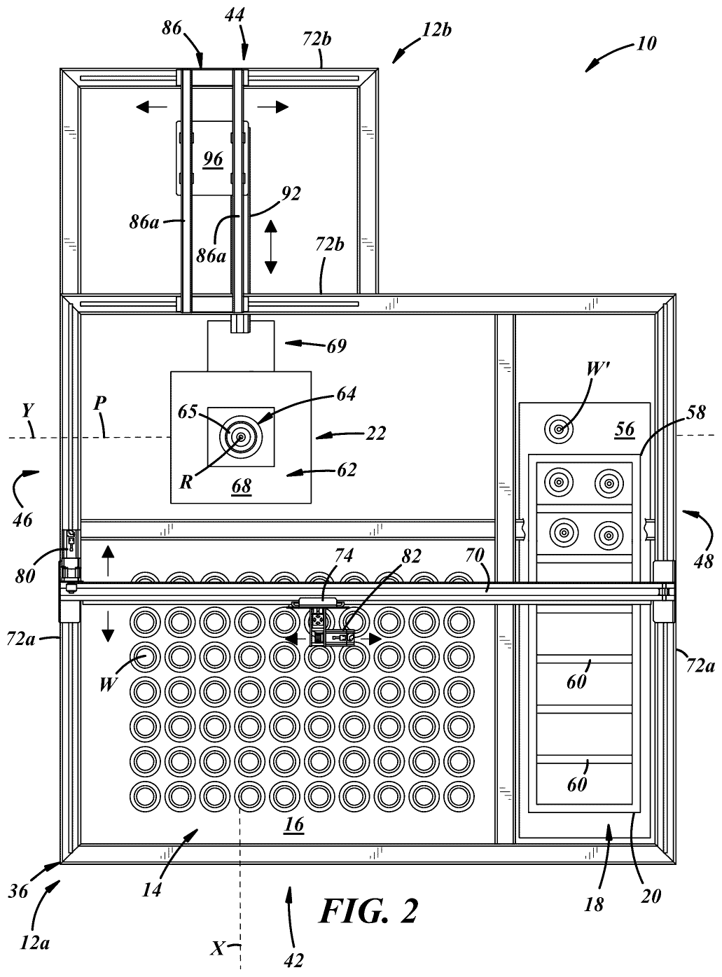

The system frame 12 may include a base frame 32 that rests on the ground and on which the rest of the system frame 12 may be supported, vertical supports 34 extending upwardly from the base frame 32, and an upper frame 36 supported by the vertical supports 34 to support the material and metallizer handlers 24, 28. The base frame 32 may also include an intermediate frame 38 disposed between the base and upper frames 32, 36. The intermediate frame 38 may be coupled to and extend between respective vertical supports 34 and may support the inbound pallet 16 and the outbound conveyor 20. The vertical supports 34 together with the horizontal base, intermediate, and upper frames 32, 38, 36 may constitute the system frame 12 and each of the system frame members 32, 34, 36, 38 may be comprised of a rigid material such as steel or aluminum. The system frame 32 may also include outboard barriers 40 extending between the base and intermediate frames 32, 38 and the vertical supports 34. These barriers 40 may be composed of fencing, metal mesh, polymeric (transparent, translucent, or opaque) panels, or any other suitable material. The system frame 12 may have a front end 42, a rear end 44 opposite the front end 42, a longitudinal axis X along with the front and rear ends 42, 44 are separated, a left side 46, a right side 48, and a lateral axis Y along which the left and right sides 46, 48 (FIG. 2) are separated. The system frame 12 may be characterized by (i) a main section 12a that surrounds the inbound station 14, the outbound station 18, and at least partially surrounds the metallizing workstation 22, and (ii) a metallizer section 12b that projects away from the main section 12a and at least partially surrounds the metallizer station 26.

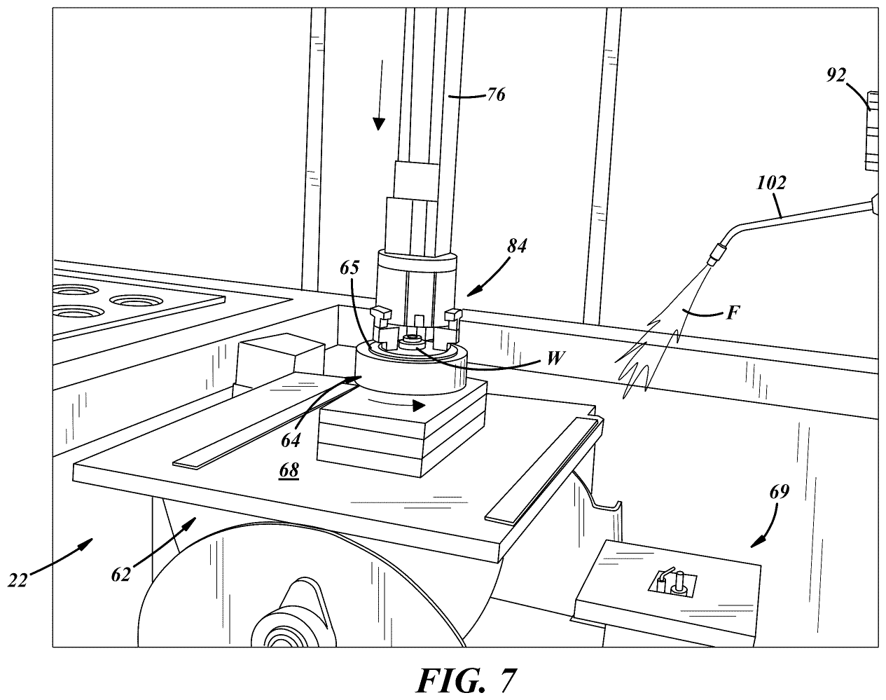

Referring now to FIGS. 1 and 6, the inbound station 14 establishes an entrance to the metallizing system 10 and houses the inbound pallet 16. The inbound pallet 16 may include a pallet base 50 and a panel 52 carried on the pallet base 50. The panel 52 establishes a plurality of workpiece holders 54, for example, pockets, to hold the worn workpieces W, which may be the same or different types of workpieces. The workpiece holders 54 also, or instead, may include posts, nubs, or any other retention features to hold the worn workpieces W in place. Moreover, as shown here, the plurality of workpiece holders 54 may be arranged in a matrix such as, for example, a rectangular matrix, to allow for easy inventory management of the worn workpieces W in need of metallizing. The inbound pallet 16 may be disposed at a height corresponding to the intermediate frame 38 and may be a structure separate from the system frame 12. In one particular implementation, the inbound pallet 16 is translatable relative to the system frame 12 into and out of the inbound station 14 on rails (not shown) or some other lateral conveyance guide.

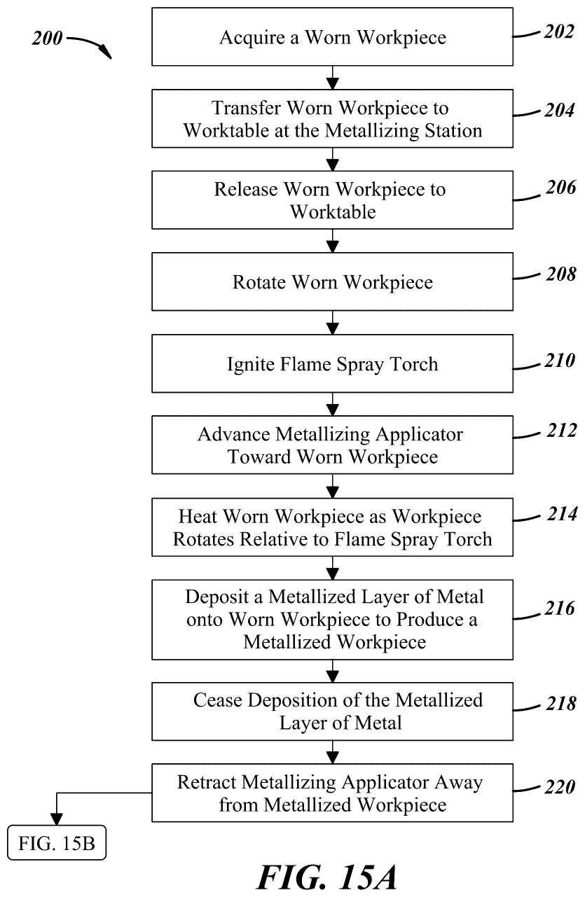

Referring now to FIGS. 1 and 14, the outbound station 18 establishes an exit or outlet of the metallizing system 10 and houses the outbound conveyor 20. The outbound conveyor 20 may include a conveying surface 56—this is the surface on which metallized workpieces W′ are placed by the material handler 24—and a reciprocating ladder 58. The reciprocating ladder 58 slides back and forth relative to the conveying surface 56. More specifically, from a rearward position, the reciprocating ladder 58 slides forward along the conveying surface 56 to a forward position and, at an end of the forward stroke, lifts and reciprocates back over the conveying surface 56 and then drops down onto the conveying surface 56 to the rearward position. The reciprocating ladder 58 has rungs 60 that progressively engage and convey the metallized workpieces W′ down along the conveying surface 56 from an input end of the conveyor 20 to an output end of the conveyor 20. The illustrated outbound conveyor 20 with its reciprocating ladder 58 is just one of many potential types of outbound conveyors that can be used as part of the metallizing system 10—other examples include roller conveyors, metal belt conveyors, and other types of conveyors suitable for conveying hot metallized workpieces. Nonetheless, the ladder conveyor disclosed here facilitates cooling of the metalized workpieces W′ so that the metallized workpieces W′ are easier to handle one they finish progressing along the conveying surface 56 to the output end of the conveyor 20 while also allowing the cooled, metallized workpieces W′ to collect in a completed area where the workpieces W′ can be retrieved.

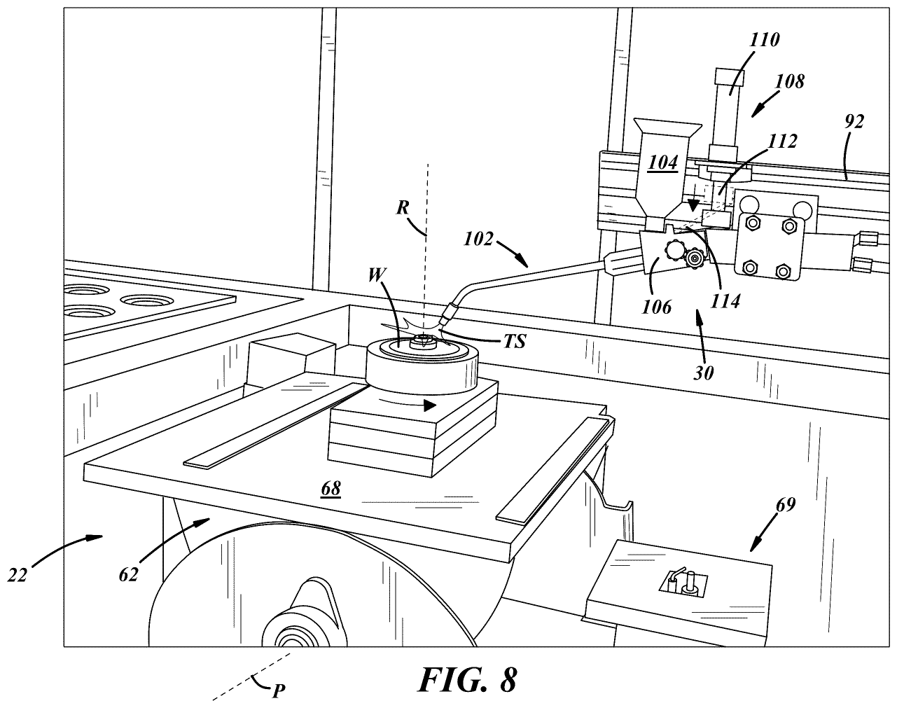

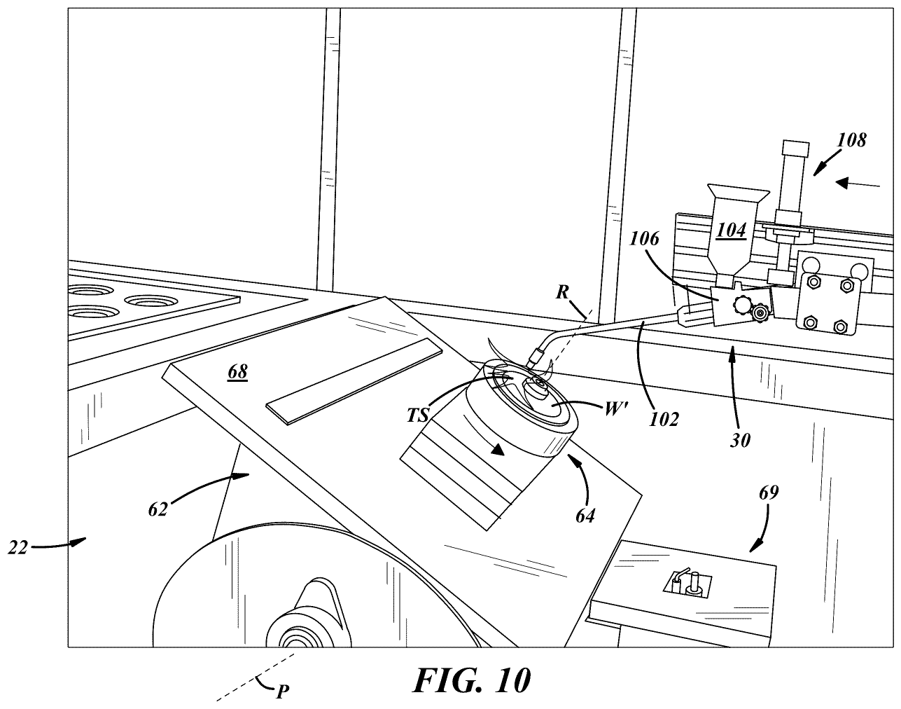

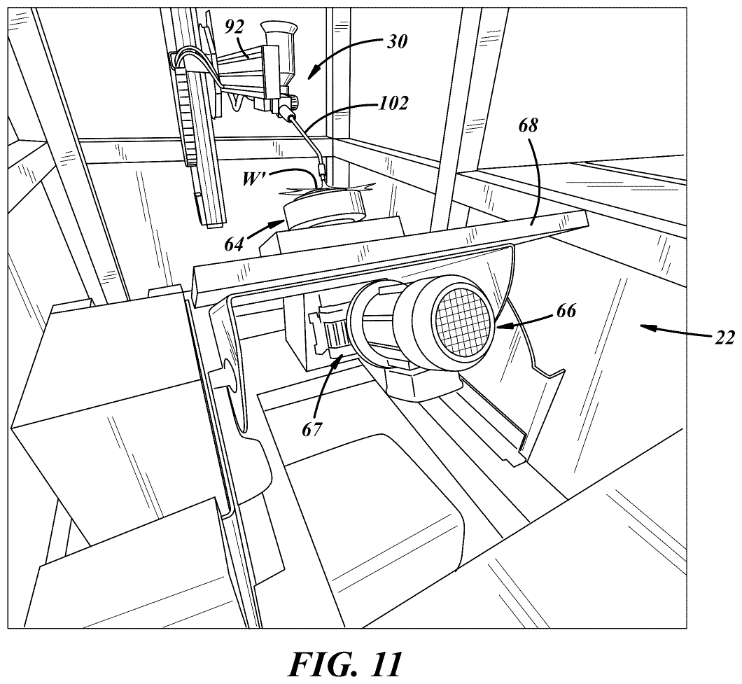

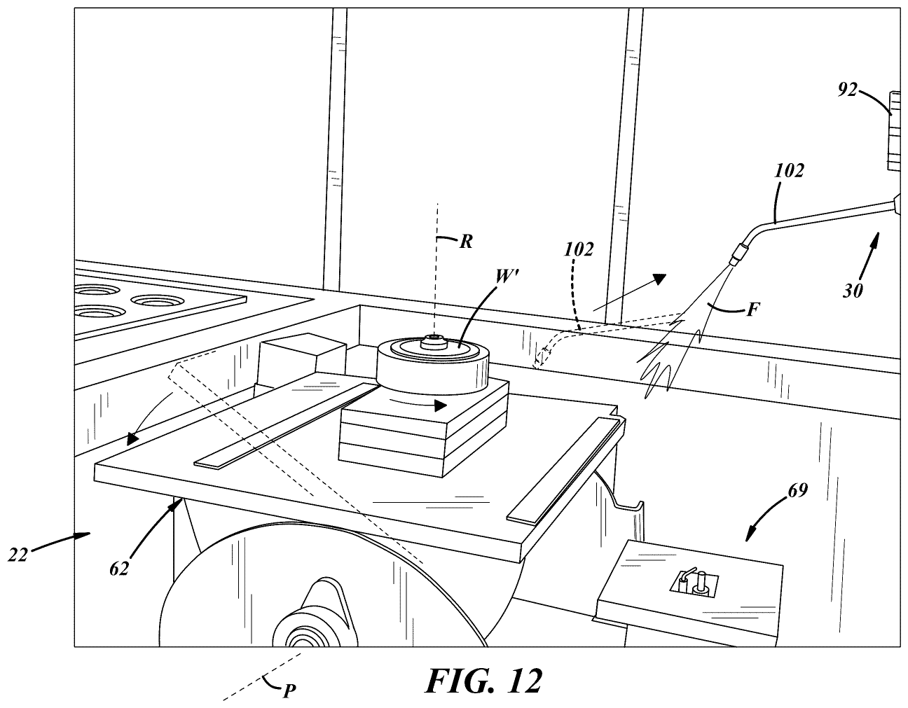

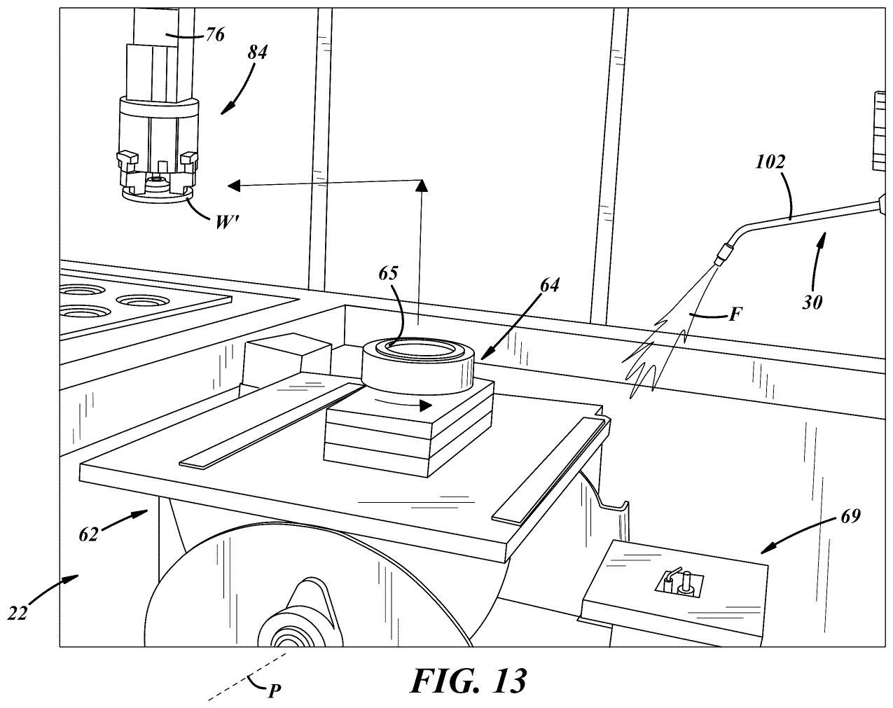

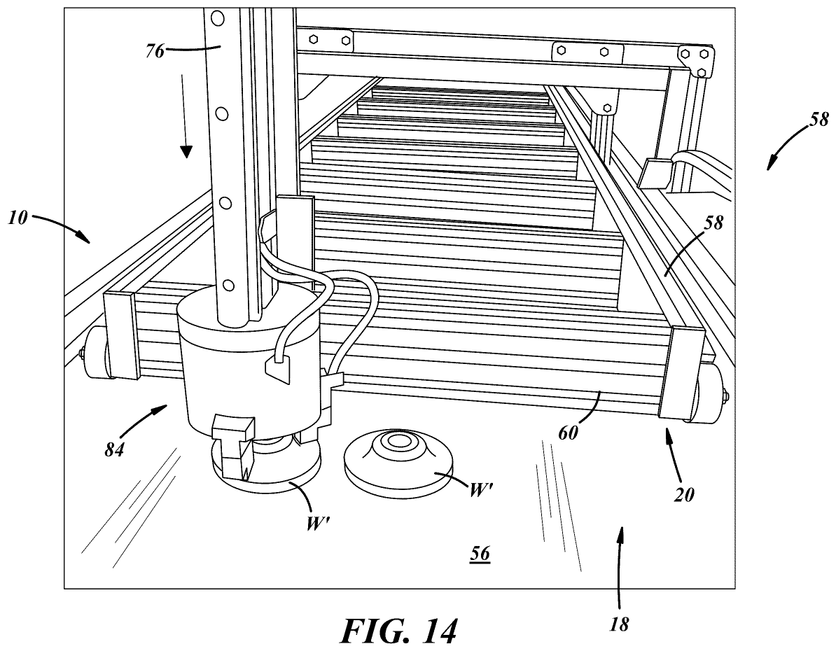

Referring now to FIGS. 1-2 and 6-13, the metallizing workstation 22 is positioned longitudinally between the inbound station 14 and the metallizer station 26. The metallizing workstation 22 includes a worktable 62 having a workpiece spindle 64. The worktable 62 may be pivotable about a pivot axis P from a first position (FIGS. 7-8), such as a horizontal position, to a second position (FIGS. 9-10), such as an oblique position. The spindle 64 is carried by the worktable 62 and includes a chuck 65. The chuck 65 is configured to receive and hold one of the worn workpieces W, preferably by actuatable jaws, and the spindle 64, including the chuck 65, is rotatable about a rotation axis R to rotate the worn workpiece W during metallizing. With reference to FIG. 11, the workstation 22 may include a motor 66 and geartrain 67, or any other suitable device(s), to rotate the spindle 64 and the chuck 65. Additionally, and although not separately shown, the metallizing workstation 22 may also include a motor and geartrain, or any other device(s), that are operable to pivot the worktable 62 about the pivot axis P. To protect underlying structural materials and components, including, for example, the motor 66 and geartrain 67 that drive rotation of the chuck 65, the worktable 62 may include one or more refractory plates 68 under the spindle 64 and the chuck 65. The metallizing workstation 22 may also include a spark igniter 69, for instance an electric spark igniter, located between the worktable 62 and the metallizing applicator 30 of the metallizer station 26, as shown in FIGS. 7-10 and 12.

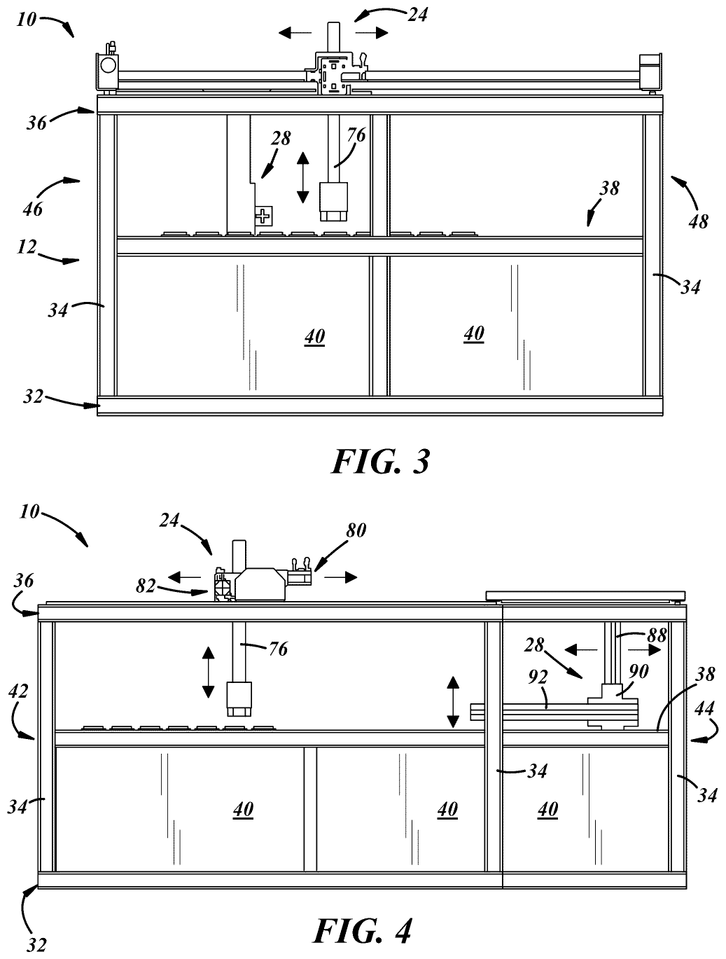

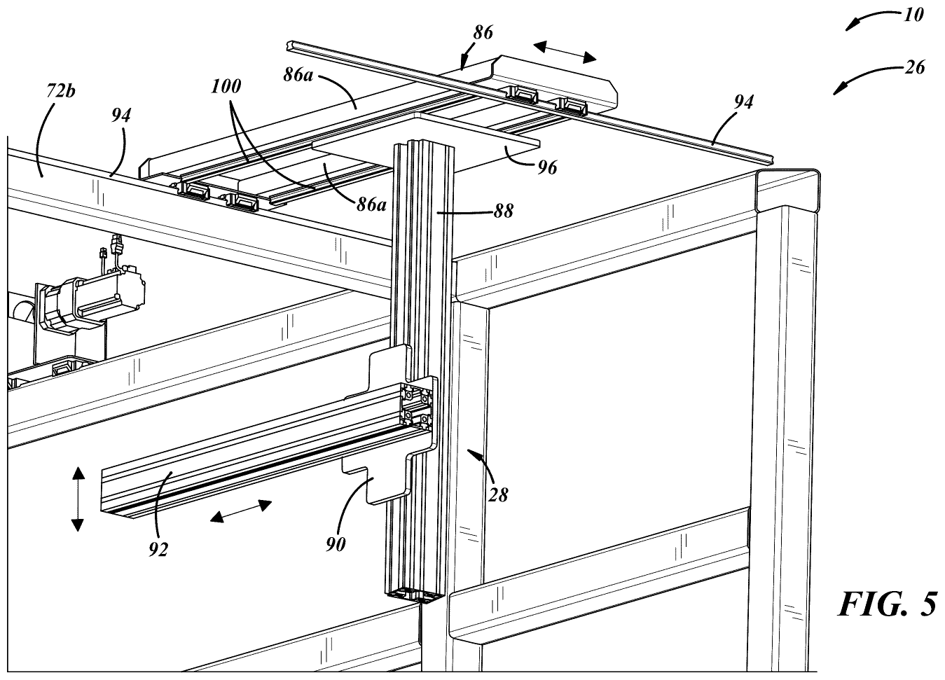

Referring now to FIGS. 1-4, the material handler 24 may be a cartesian coordinate gantry configured to move horizontally (laterally and longitudinally) and vertically. The material handler 24 may be an overhead gantry coupled to the upper frame 36 of the system frame 12, for example, and may include a handler gantry bridge 70 that is carried between corresponding beams 72a of the upper frame 36 and is also horizontally traversable along those beams 72a. The material handler 24 may also include a handler carriage or arm carriage 74 and a gripper arm 76. The arm carriage 74 is carried by the handler gantry bridge 70 and is also horizontally traversable along the gantry bridge 70, and the gripper arm 76 is carried by the arm carriage 74 and is vertically traversable with respect to the arm carriage 74. The material handler 24 may include bearing rails 78 coupled to the beams 72a of the upper frame 36 and, although not separately shown, roller bearings coupled to the gantry bridge 70 for riding along the bearing rails 78 and one or more belt drives, geartrains, or any other drive systems suitable to move the gantry bridge 70 back and forth over the inbound station 14, the metallizing workstation 22, and the outbound station 18.

The material handler 24 may include a carriage servomotor 80 as part of a belt drive to move the arm carriage 74 back and forth along the handler gantry bridge 70, or may include a geartrain or any other drive system suitable to move the arm carriage 74. Likewise, the material handler 24 may include an arm servomotor 82 as part of a belt drive to move the gripper arm 76 up and down relative to the arm carriage 74, or may include a geartrain or any other drive system suitable to move the gripper arm 76. Additionally, as shown in FIGS. 6-7 and 13-14, the material handler 24 includes a gripper end-effector 84 disposed on an end of the gripper arm 76 that is operable to acquire the worn and metallized workpieces W, W′ and transfer the workpieces W, W′ within the system 10. Indeed, the gripper end-effector 84 is able to acquire a worn workpiece W from the inbound pallet 16 at the inbound station 14, transfer the worn workpiece W to the worktable 62 at the metallizing workstation 22, and release the worn workpiece W onto the chuck 65 of the spindle 64. After the worn workpiece W is metallized into the metallized workpiece W′, the gripper end-effector 84 is able to acquire the metallized workpiece W′ from the chuck 65 of the spindle 64, transfer the metallized workpiece W′ to the outbound station 18, and release the metallized workpiece W′ onto the outbound conveyor 20. Although the material handler 24 of the illustrated embodiment may be a gantry type of material handler, an articulating robot, or any other type of material handler may be used that is suitable to handle the workpieces W, W′.

Referring back to FIGS. 1-5, the metallizer station 26 is supported by the metallizer section 12b of the frame 12 and includes the metallizer handler 28. In the illustrated embodiment, the metallizer handler 28 is an overhead gantry that is coupled to the upper frame 36 of the system frame 12 and includes a metallizer gantry bridge 86, a vertical support 88, a metallizer arm carriage 90, and a metallizer arm 92. The metallizer gantry bridge 86 is carried between corresponding beams 72b of the metallizer section 12b of the upper frame 36 and is horizontally traversable along those beams 72b. The vertical support 88 is coupled to the metallizer gantry bride 86 and the metallizer arm carriage 90 is carried by the vertical support 88 and is vertically traversable along the vertical support 88. The metallizer arm 92 is carried by the metallizer arm carriage 90 and is horizontally traversable with respect to the arm carriage 90, and the metallizing applicator 30 is coupled to the metallizer arm 92. To that end, the metallizing applicator 30 is movable toward and away from the spindle 64 of the metallizing workstation 22 through corresponding horizontal movement of the metallizer arm 92 relative to the metallizer arm carriage 90, and is also movable up and down relative to the spindle 64 through corresponding vertical movement of the metallizer arm carriage 90 relative to the vertical support 88. The metallizer handler 28 may also include bearing rails 94 coupled to the beams 72b of the upper frame 36 and, although not separately shown, any suitable bearings coupled to the metallizer gantry bridge 86 for riding along the bearing rails 94.

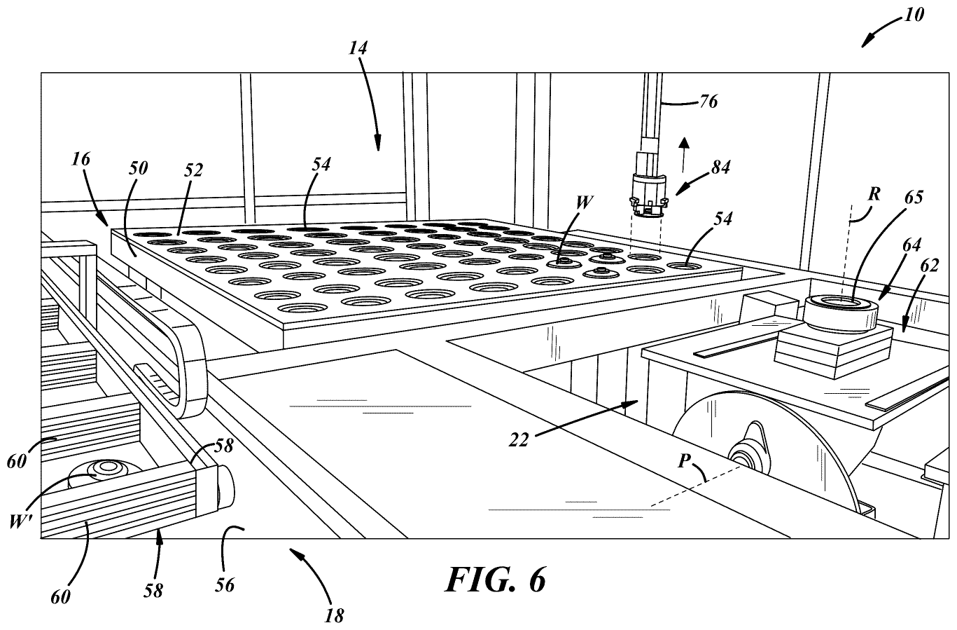

The metallizer gantry bridge 86 may include a pair of bridge members 86a coupled to one another at opposite ends thereof. The vertical support 88 may be coupled to a mounting plate 96 that is coupled to the bridge members 86a. The mounting plate 96 may be coupled to bearings 98 (FIG. 1), which, in turn, may be coupled to bearing rails 100 (FIG. 5) coupled to the metallizer gantry bridge 86. Additionally, and although not separately shown, the metallizer handler 28 may include one or more belt drives, geartrains, or any other drive systems suitable to move the metallizer gantry bridge 86 back and forth with respect to the metallizing workstation 22, to move the vertical support 88 back and forth between the beams 72b, to move the metallizer arm carriage 90 up and down along the vertical support 88, and to move the metallizer arm 92 back and forth with respect to the arm carriage 90. Although the metallizer handler 28 of the illustrated embodiment may be a gantry type of metallizer handler, an articulating robot, or any other type of handler may be used that is suitable to move the metallizing applicator 30.

Referring now to FIGS. 7-13, the metallizing applicator 30 may include a flame spray torch 102, a metal hopper 104 that holds a metal material in powder form and is in flow communication with the flame spray torch 102, a flow valve 106 between the metal hopper 104 and the flame spray torch 102, and a valve actuator 108 to actuate the flow valve 106. The flame spray torch 102 may include an oxy-acetylene Colmonoy torch, or any other torch, operable to heat the worn workpiece W being metallized with an emitted flame F (FIG. 7), receive powdered metal material into the torch flame to create a thermal metallic spray TS (FIG. 8) that includes depositable molten metal, and apply the thermal metallic spray TS onto the worn workpiece W to deposit a metallized layer of metal and, thus, produce a metallized workpiece W′. The term “depositable molten metal” means metal in particulate form that is molten or semi-molten such that the metal particles will blend or fuse together into the metallized layer of metal. In the illustrated embodiment, and as shown in FIG. 8, the valve actuator 108 includes a pneumatic cylinder 110 fixed to the metallizer arm 92 and a piston 112 movable with respect to the cylinder 110 to displace a movable flap 114 of the valve 106 so that introduction of the powdered metal material into the torch flame can be controlled. Actuating the movable flap 114 in this particular embodiment opens the valve 106 to allow powdered metal material to flow from the hopper 104 and into the torch 102 for application to the worn workpiece W. In other embodiments, the valve actuator 108 may include an electromechanical device, such as a solenoid or linear actuator, to actuate the flow valve 106.

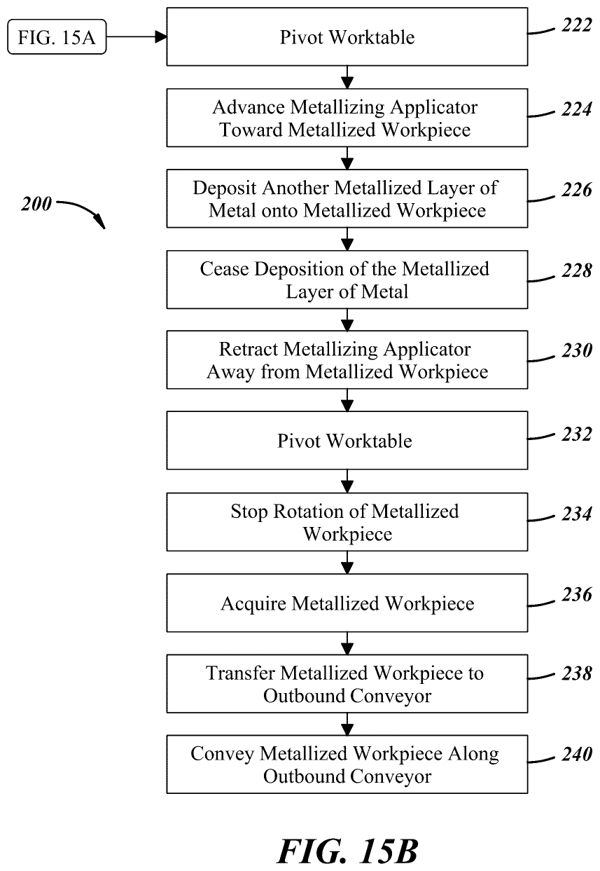

FIGS. 15A and 15B show an illustrative method 200 for metallizing worn workpieces W, such as worn mold components, and is described in the context of using the metallizing system described above and shown in FIGS. 1-14, although the method 200 may be practiced with other metallizing systems not shown or described herein. The metallizing method 200 includes a variety of steps 202-240, some or all of which may be performed sequentially with respect to other steps and/or simultaneously with one or more other steps. The metallizing method 200 ultimately involves delivering a worn workpiece W to the worktable 62 and, more specifically, to the chuck 65 of the rotatable spindle 64, and metallizing the worn workpiece W to produce a metallized workpiece W′, with at least the metallizing operation being automated. An “automated” metallizing operation means that the worn workpiece W is moved relative to a flame and that a metallized layer of metal is applied to the worn workpiece W without hand manipulation of either the worn workpiece W or the flame spray torch 102 during such metallization.

In a worn workpiece acquiring step 202, one of the worn workpieces W is acquired. In the metallizing system 10, for example, the worn workpiece W is acquired from the inbound pallet 16 at the inbound station 14. This includes activating the material handler 24 so that the gripper end-effector 84 grips one of the worn workpieces W, which may involve moving one or more of the handler gantry bride 70 and the arm carriage 74 to bring the gripper arm 76 over the inbound pallet 16 and above the worn workpiece W to be metallized and then moving the gripper arm 76 downwards so that the gripper end-effector 84 can grip the intended workpiece W. Next, in a worn workpiece transfer step 204, the acquired worn workpiece W is moved to the metallizing workstation 22 where automated metallizing is performed. In the metallizing system 10, the acquired worn workpiece W, which is being held by the gripper end-effector 84, is moved by the material handler 24 from the inbound pallet 16 to the metallizing workstation 22 by activating the material handler 24 to move one or more of the handler gantry bride 70 and the arm carriage 74 and, optionally, lifting the gripper arm 76, to achieve the requisite movement of the workpiece W. Once at the metallizing workstation 22, the gripper end-effector 84 places the worn workpiece W on the chuck 65 of the rotatable spindle 64, which is carried by the pivotable worktable 62. The pivotable worktable 62 is preferably oriented in a horizontal position during the worn workpiece transfer step 204.

In a worn workpiece releasing step 206, the worn workpiece W is released at the metallizing station 22. In the metallizing system 10, for instance, the worn workpiece W is released by the gripper end-effector 84 and is received by the chuck 65 of the spindle 64. At this time, the actuatable jaws of the chuck 65 may be engaged to retain the worn workpiece W. Then, in a workpiece rotation step 208, the spindle 64 is rotated to rotate the chuck 65 about the rotation axis R, which, in turn, rotates the worn workpiece W correspondingly. The spindle 64 and the chuck 65 may be rotated by activating the motor 66 and geartrain 67 at the metallizing workstation 22. In an ignition step 210, the flame spray torch 102 is ignited. In the metallizing system 10, the flame spray torch 102 may be ignited by activating the metallizer handler 28 to move the flame spray torch 102 of the metallizing applicator 30 to the spark igniter 69, supplying an ignitable gas that includes oxygen and fuel (e.g., acetylene), for example, through the torch 102, and activating the igniter 69. Moving the flame spray torch 102 to the igniter is carried out by moving one or more of the metallizer gantry bridge 86, the metallizer arm carriage 90, and the metallizer arm 92 as needed to bring the torch 102 into proximity with the igniter 69.

In a metallizing applicator advancing step 212, the metallizing applicator 30, with the ignited flame spray torch 102, is advanced toward the worn workpiece W to the advanced position. In the metallizing system 10, the metallizing applicator 30 is advanced toward the worn workpiece W, which is retained in the chuck 65 of the spindle 64 on the pivotable worktable 62, by activating the metallizer handler 28 to move one or more of the metallizer gantry bridge 86, the metallizer arm carriage 90, and the metallizer arm 92. In a workpiece heating step 214, the worn workpiece W is heated while the worn workpiece W is rotated relative to the flame spray torch 102 and, more particularly, relative to and through the emitted flame F of the flame spray torch 102. For example, in the metallizing system 10, this heating step 214 may include impinging the flame F from the flame spray torch 102 onto the worn workpiece W as the motor 66 and geartrain 67 rotate the spindle 64 and the chuck 65 and, thus, the retained worn workpiece W within the flame F. Such heating of the worn workpiece W with the flame F rapidly increases the temperature of the selected and localized surfaces of the worn workpiece W that are affected by the flame F to a temperature conducive to fused adhesion of the powdered metal material. Unlike heating in an oven, the heating step 214 described here quickly heats the selected surfaces of the worn workpiece W that are intended to receive the metallized layer without having to expend needless energy heating the entire worn workpiece W. The flame intensity, fuel gas used, flame impingement time, and other heating parameters may be adjusted to achieve the desired workpiece surface temperature.

The method 200 also includes a metal application step 216 in which a metallized layer of metal is deposited onto the worn workpiece W to produce the metallized workpiece W′. In the metallizing system 10, for example, this step 216 may involve activating the valve actuator 108 of the metallizing applicator 30 to actuate the flow valve 106 by displacing the movable flap 114, which in turn introduces the powdered metal material into the flame F being emitted from the flame spray torch 102 to create the thermal metallic spray TS. As the worn workpiece W is rotated relative to the flame in torch 102 and through the thermal metallic spray TS, the metal contained within the thermal metallic spray TS contacts and fuses to the worn workpiece W, thus resulting in the deposition of the metallized layer of metal to the worn workpiece W to produce the metallized workpiece W′. The metallizing time of this step 216 may vary depending on the amount of metallized metal desired to be applied. Additionally, the flame intensity, fuel gas used, flame impingement time, and other heating parameters may be adjusted to achieve desired metal application qualities. Moreover, the workpiece heating step 214 and the metal application step 216 may be performed when the worktable 62 is oriented in the first position, for instance, the horizontal position, or when the worktable 62 is oriented in the second position, for example, an oblique position.

After at least a portion of the metallized layer is deposited, a metal application cessation step 218 is performed that involves ceasing deposition of the metallized layer of metal to the now metallized workpiece W′. For example, in the metallizing system 10, this step 218 may include deactivating the valve actuator 108 such that the movable flap 114 of the flow valve 106 returns to its initial position under spring pressure, for example, to stop flow of powdered metal material from the metal hopper 104 to the flame spray torch 102. Next, in a metallizing applicator retracting step 220, the metallizing applicator 30 is retracted away from the metallized workpiece W′ to the retracted position. For example, in the metallizing system 10, the metallizing applicator 30 is retracted away from the metallized workpiece W′, which is still retained in the chuck 65 of the spindle 64 on the pivotable worktable 62, by activating the metallizer handler 28 to move one or more of the metallizer gantry bridge 86, the metallizer arm carriage 90, and the metallizer arm 92. The emitted flame F of the flame spray torch 102 may also—but does not have to—be extinguished by stopping the flow of the ignitable gas through the torch 102 after the metal application cessation step 218 or the metallizing applicator retracting step 220. At this point, the metallized workpiece W′ may include a sufficient metallized layer of metal that the workpiece W′ may be acquired by the gripper end-effector 84 the gripper arm 76, transferred to the outbound conveyor 20 of the outbound station 18, and progressed along the outbound conveyor 20 as described in more detail below (steps 234-240), or additional metal may be applied to the metallized workpiece W′ in one or more additional rounds of metallizing.

If additional metallizing is desired, the pivotable worktable 62 may be pivoted to a different position in a worktable pivoting step 222, for example, to change the distance and/or angle at which the flame F impinges the metalized workpiece W′ and the powdered metal material is applied as a metallized layer of metal during the next round of metallizing. In the metallizing system 10, the worktable pivoting step 222, if practiced, may include pivoting the worktable about the pivot axis P from the first position (e.g. horizontal position) to the second position (e.g. oblique position) or from the second position (e.g., oblique position) to the first position (e.g., horizontal position) by activating a worktable motor and geartrain to pivot the worktable 62 in the intended angular direction. Regardless of whether the worktable pivoting step 222 is practiced, another metallizing applicator advancing step 224 is performed to again advance the metallizing applicator 30 toward the metallized workpiece W′ to the advanced position. And, depending on whether or not the flame F from the flame spray torch 102 was previously extinguished, the ignition step in which the flame spray torch 102 is ignited may be performed as described above prior to the metallizing applicator advancing step 224, although when multiple rounds of metallizing are being practiced the flame F preferably is not extinguished between the previous metal application step 216 and the subsequent metal application step.

Another metal application step 226 may be performed in which in which another metallized layer of metal is deposited onto the metallized workpiece W′, typically over the previously deposited metallized layer of metal, as the workpiece W′ is rotated relative to the flame spray torch 102 and through the thermal metallic spray TS. Another workpiece heating step may also be performed prior to the metal application step 226 if the metallized workpiece W′ lost too much heat after the previous metal application step 216. After at least some of the metallized layer is deposited, another metal application cessation step 228 is performed, which involves ceasing deposition of the metallized layer of metal to the metallized workpiece W′, followed by another metallizing applicator retracting step 230 in which the metallizing applicator 30 is retracted away from the metallized workpiece W′ to the retracted position. The pivotable worktable 62 may then be pivoted back to the first position (e.g., the horizontal position) in another worktable pivoting step 232 if the worktable 62 was previously pivoted in the worktable pivoting step 222 from the first position to the second position (e.g., the oblique position). The metallizing applicator advancing step 224, the metal application step 226, the metal application cessation step 228, and the metallizing applicator retracting step 230, and the worktable pivoting step 232 mentioned here in connection with the additional round of metallizing may be carried out in the same matter as the corresponding steps 212, 216, 218, 220, 222 described above.

After the initial metal application cessation step 218 and preferably after the initial metallizing applicator retracting step 220, if no additional metallizing is practiced, or otherwise after the additional metal application step 228 and preferably after the additional metallizing applicator retracting step 230, the rotation of the metallized workpiece W′ is stopped in a workpiece rotation cessation step 234 by stopping the rotation of the spindle 64 and the chuck 65. The metallized workpiece W′is then acquired in a metallizing workpiece acquiring step 236 with the pivotable worktable 62 preferably oriented in the horizontal position. In the metallizing system 10, this step 236 includes activating the material handler 24 so that the gripper end-effector 84 grips the metallized workpiece W.' Gripping the metallized workpiece W′ with the gripper end-effector 84 involves moving one or more of the handler gantry bride 70 and the arm carriage 74 to bring the gripper arm 76 to the metallizing station 22 and over the metallized workpiece W′ and then moving the gripper arm 76 downwards so that the gripper end-effector 84 can grip the metallized workpiece W′ that is still retained in the chuck 65. Once the gripper end-effector 84 has engaged and gripped the metallized workpiece W′, the actuatable jaws of the chuck 65 are disengaged from the workpiece W′ and the gripper arm 76 is moved upwardly to remove the metallized workpiece W′ from the chuck 65 of the rotatable spindle 64 at the metallizing workstation 22.

The metallized workpiece W′ is next transferred from the metallizing workstation 22 to the outbound conveyor 20 of the outbound station 18 in a metallized workpiece transfer step 238. For instance, in the metallizing system 10, the acquired metallized workpiece W′, which is being held by the gripper end-effector 84, is moved by the material handler 24 from the metallizing workstation 22 to the outbound conveyor 20 by activating the material handler 24 to move one or more of the handler gantry bride 70 and the arm carriage 74 to achieve the requisite movement of the metallized workpiece W′. The metallized workpiece W′ is then released by the gripper end-effector 84 of the gripper arm 76 onto the outbound conveyor 20. In a metallized workpiece conveyance step 240, the metallized workpiece W′ is conveyed along the outbound conveyor 20 to an outlet of the metallizing system 10. Here, in the metallizing system 10, the gripper end-effector 84 places the metallized workpiece W′ onto the conveying surface 56 of the outbound conveyor 20 and the reciprocating ladder 58 progresses the metallized workpiece W′ along the conveying surface 56 to the output end of the conveyor 20, which may also be the outlet of the system 10, while the workpiece W′ cools. The reciprocating ladder 56 reciprocates between a rearward position to a forward position and, in doing so, the rungs 60 of the ladder 58 engage the metallized workpiece W′ and shuffle the workpiece W′ along the conveying surface 56, eventually bringing the workpiece W′ to the output end of the outbound conveyor 20. Once at the output end of the outbound conveyor 20—or anytime the metallized workpiece W′ is on the conveyor 20—the metallized workpiece W′ may be retrieved and removed from the metallizing system 10.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, or feature, and should not be construed as rendering indefinite any disclosure herein. Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. The present disclosure is intended to embrace all embodiments and modifications of the subject matter of this application that fall within the scope of the accompanying claims.

1. A metallizing system comprising:
a metallizing workstation including a worktable configured to receive and rotate a worn workpiece; and
a metallizer station including a metallizer handler and a metallizing applicator carried by the metallizer handler, the metallizing applicator being movable towards and away from the worktable and including a flame spray torch configured to deposit a metallized layer of metal onto the worn workpiece as the worn workpiece rotates relative to the flame spray torch.

2. The metallizing system set forth in claim 1, wherein the worktable is pivotable about a pivot axis between a first position and a second position.

3. The metallizing system set forth in claim 1, wherein the metallizer handler includes an overhead gantry having a metallizer arm that carries the metallizer applicator.

4. The metallizing system set forth in claim 1, wherein the metallizing applicator includes further includes a metal hopper that holds a powdered metal material and is in flow communication with the flame spray torch, a flow valve between the metal hopper and the flame spray torch, and a valve actuator to actuate the flow valve.

5. The metallizing system set forth in claim 1, wherein the metallizing workstation further includes a spark igniter located between the worktable and the metallizing applicator.

6. The metallizing system set forth in claim 1, wherein the worktable carries a rotatable spindle having a chuck configured to receive and retain the worn workpiece, the spindle being rotatable about a rotation axis.

7. The metallizing system set forth in claim 1, further comprising:
a material handler configured to acquire the worn workpiece, move the worn workpiece to the metallizing workstation, and release the worn workpieces to the worktable.

8. The metallizing system set forth in claim 7, wherein the material handler includes an overhead gantry having a gripper arm configured to acquire the worn workpiece and release the worn workpiece to the worktable at the metallizing station.

9. The metallizing system set forth in claim 1, further comprising:
an inbound pallet configured to hold the worn workpiece.

10. The metallizing system set forth in claim 1, further comprising:
an outbound conveyor configured to receive a metallized workpiece from the metallizer station.

11. A metallizing system for metallizing worn workpieces into metallized workpieces, the metallizing system comprising:
an inbound pallet including a plurality of workpiece holders, each workpiece holder being configured to hold a worn workpiece;
an outbound conveyor having a conveying surface;
a metallizing workstation including a worktable having a workpiece spindle that is rotatable about a rotation axis and includes a chuck;
a metallizer station including a metallizer handler and a metallizing applicator carried by the metallizer handler, the metallizing applicator being movable towards and away from the workpiece spindle and including a flame spray torch configured to emit a flame and receive powdered metal material into the flame to create a thermal metallic spray; and
a material handler including a gripper arm that has a gripper end-effector, the gripper end-effector configured to acquire a worn workpiece from the inbound pallet, transfer the worn workpiece to the metallizing workstation, and release the worn workpiece to the chuck of the workpiece spindle, and also configured to acquire a metallized workpiece from the chuck of the workpiece spindle, transfer the metallized workpiece to the outbound conveyor, and release the metallized workpiece onto the conveying surface of the outbound conveyor.

12. The metallizing system set forth in claim 11, wherein the outbound conveyor includes a reciprocating ladder conveyor.

13. The metallizing system set forth in claim 11, wherein the worktable is pivotable about a pivot axis between a first position and a second position.

14. The metallizing system set forth in claim 11, wherein the metallizer handler includes an overhead gantry having a metallizer arm that carries the metallizer applicator, and wherein the material handler includes an overhead gantry having the gripper arm.

15. The metallizing system set forth in claim 11, wherein the metallizing applicator includes further includes a metal hopper that holds a powdered metal material and is in flow communication with the flame spray torch, a flow valve between the metal hopper and the flame spray torch, and a valve actuator to actuate the flow valve.

16. The metallizing system set forth in claim 11, wherein the metallizing workstation further includes a spark igniter located between the worktable and the metallizing applicator.

17. The metallizing system set forth in claim 11, further comprising:
an upper frame that supports each of the metallizer handler and the material handler; and
wherein the metallizer handler includes a metallizer gantry bridge carried by the upper frame, a vertical support coupled to the metallizer gantry bridge, a metallizer arm carriage carried by the vertical support and which carries a metallizer arm, the metallizer arm being horizontally traversable with respect to the metallizer arm carriage;
wherein the material handler includes a handler gantry bridge carried by the upper frame and an arm carriage carried by the handler gantry bridge, the gripper arm being carried by the arm carriage and also being vertically traversable with respect to the arm carriage.

18. A method of metallizing a worn workpiece to produce a metallized workpiece, the method comprising:
delivering a worn workpiece to a rotatable workpiece spindle carried on a worktable, the rotatable workpiece spindle having a chuck and wherein the worn workpiece is received in the chuck;
advancing a metallizing applicator towards the worktable and the worn workpiece, the metallizing applicator including a flame spray torch that emits a flame;
rotating the workpiece spindle to rotate the worn workpiece relative to the flame spray torch such that the worn workpiece rotates through the flame to heat the worn workpiece;
depositing a metallized layer of metal onto the worn workpiece to produce a metallized workpiece by introducing a powdered metal material into the flame of the flame spray torch to create a thermal metallic spray while continuing to rotate the workpiece spindle such that the worn workpiece is rotated relative to the flame spray torch and through the thermal metallic spray; and
retracting the metallizing applicator away from the metallized workpiece and the worktable.

19. The method set forth in claim 18, wherein the step of delivering the worn workpiece to the worktable comprises:
acquiring the worn workpiece with a gripper arm of a material handler;
transferring the worn workpiece to the worktable with the gripper arm of the material handler; and
releasing the worn workpiece from the gripper arm to the worktable.

20. The method set forth in claim 19, wherein the step of acquiring the work workpiece comprises acquiring, with the gripper arm of the material handler, the worn workpiece from an inbound pallet that includes a plurality of worn workpieces.

21. The method set forth in claim 18, wherein, after the step of retracting the metallizing applicator away from the metallized workpiece and the worktable, the method further comprises:
pivoting the worktable about a pivot axis from a first position to a second position;
advancing the metallizing applicator again towards the worktable and the worn workpiece, the metallizing applicator including a flame spray torch that emits a flame; and
depositing another metallized layer of metal onto the metallized workpiece by introducing a powdered metal material into the flame of the flame spray torch to create a thermal metallic spray and continuing to rotate the metallized workpiece relative to the flame such that the metallized workpiece rotates through the thermal metallic spray.

22. The method set forth in claim 18, further comprising:
moving the metallized workpiece from the worktable to an outbound conveyor.

23. The method set forth in claim 22, further comprising:
sliding a reciprocating ladder back and forth to convey the metallized workpiece along a conveying surface of the outbound conveyor towards an output end of the outbound conveyor.
